(19) United States
(12) Patent Application Publication
(10) Pub. No.: US 2004/0024761 A1
(43) Pub. Date: Feb. 5, 2004

(54) Web-besed, industry specific, staffing interactive database

(76) Inventor: Steven J. Kolbe, Orefield, PA (US)

Correspondence Address: Sanford J. Piltch, Esq., Suite 201, 1132 Hamilton Street, Allentown, PA, 18101-1024, US

(21) Appl. No.: 10/193,981

(22) Filed: Jul. 13, 2002

(51) Int. Cl. G06F 7/00

(52) U.S. Cl. 707/9

(57) ABSTRACT

The present invention is directed towards an interactive web-based database for use by one or more hiring facilities in a particular industry and associated with temporary staffing professionals to coordinate the availability of the staffing professionals with the temporary staffing requirements of the hiring facilities. The database, and access thereto, is designed to permit the hiring facilities to more easily schedule temporary staffing professionals while giving the professionals greater freedom in selecting their assignments. Hiring facilities will be permitted to search the database for potential temporary staff, post available temporary positions, notify qualified professionals of temporary positions, maintain data files of qualified professionals, and communicate with large groups of staffing professionals through broadcast e-mail messaging.

### FIELD OF THE INVENTION

This invention relates to a method for scheduling temporary staff for specific industries using the Internet and a web-based interactive database. The web-based staffing system provides greater flexibility in offering and accepting temporary positions or postings by both the employer and the temporary staff employee. This invention addresses industry wide staffing problems, by bringing all participants of the industry together, versus company specific staffing solutions, which only include company selected entities onto a single website or database. By developing this “open” solution, this invention permits all potential employees, in a specific profession or industry, to have direct contact with all potential employers in that same profession or industry and vice versa. By way of example the healthcare industry will be used in the following narrative to explain the invention, however the invention may be used for a myriad of professions and industries by simply substituting the employee or staffing types.

### BACKGROUND OF THE INVENTION

The present system for obtaining temporary healthcare professionals at any number of healthcare facilities is to request an employee from a temporary staffing agency or through the use of an in-house staffing pool, which will be collectively referred to as an Intermediary. This involves one or more supervisors making requests of the personnel office for temporary staff for one or more specialized duties during one, or a plurality of shifts. The result is a hodge-podge of requests cobbled together with a varying number of skill levels, shift timings, duration of requested staffings, and other specialized requirements received in the personnel office and used in-house, or communicated to a temporary staffing agency. The results of the requests may be less than expected, with one Intermediary being unable to fulfill all of the staffing requests for one shift, let alone a single day. Sometimes, the staffing requests for a single mid-sized healthcare facility can only be fulfilled using several Intermediaries, or temporary staffing agencies, as well as direct hires to meet at least the minimum staffing requirements for a shift

In the event that a single Intermediary can locate and provide all of the temporary staffing requirements for one healthcare facility, this is accomplished utilizing voice or message type telecommunications devices which are mono-directional and require the re-contacting of the healthcare professional to confirm availability to fill the temporary position. The time required to collect and collate the requests for temporary staffing, and then to locate and confirm the availability of the healthcare professionals on short notice is an enormous undertaking. Coupled with this effort is the similar task of listing the temporary staff with the appropriate requesters in order to provide notice of fulfillment of the temporary staffing request with, at least, the name of the healthcare professional that will be filling the position.

The time spent telephoning between the requesting supervisor, the personnel office, the temporary staffing agency and the healthcare professional, and the return telephone calls confirming the arrangement can span many hours, if not days. Multiply a single request by fifty or more, and one can see that the task becomes both tedious and somewhat overwhelming. But with the advent of the Internet and the ability of many healthcare professionals to have access through public or private Internet service providers, the onerous task of requesting and scheduling temporary healthcare providers may have become less burdensome, and more direct.

A healthcare facility, knowing that it will need a number of temporary healthcare professionals on a particular day for duties ranging from the emergency or operating rooms to critical or coronary care in advance of the day and time of the temporary staffing need, can place a direct offer for the temporary position to a number of healthcare professionals and have the healthcare professionals selectively respond, without the need for an Intermediary. The process of collecting requests for temporary staff and making offers to potential employees for the temporary position is completed by connecting through the Internet to the web-based interactive database of the present invention. The inter-related functionalities of this database are the crux of this invention.

The offer of temporary employment will be broadcast via the interactive database to registered user healthcare professionals, who have been approved by the offering healthcare facility, meet the requirements for that job, and have been selected to receive an offer for consideration. The offer is reviewable by each of the professionals in the private calendar section of their user “page” located within the web-based database. The calendar section will include details of the temporary position, the reporting time and shift duration, payment rate, etc. An abridged description of the offer may also be viewed via a web-enabled cell phone or professional data assistant. The healthcare professional can directly accept the staffing offer through the web-based interactive database so that the position can be filled in as short a period of time as possible. Upon acceptance of an offer of temporary employment, calendars of both the healthcare professional and the healthcare facility are updated to indicate the accepted temporary employment and confirmatory e-mails are sent to both parties with the information pertaining to the employment.

All healthcare professionals will be permitted to register with the interactive web-based database providing basic information, such as the type of professional license or certification, the times and areas that may be considered for temporary or part-time employment. All participating healthcare facilities will have access to all registered professionals and will be able to search for qualified personnel by type of professional license or certification and location. Registered professionals may be contacted by healthcare facilities, through the use of database generated recruitment e-mails, for placement on an approved list so that the professional can be contacted with opportunities for temporary employment. The offers for temporary employment will be made via the Internet website, with a corresponding e-mail notice and an optional wireless connection, i.e. web-enabled cell phone, etc. The database will allow the healthcare professional to be approved for employment with a plurality of healthcare facilities and receive and review as many offers of temporary employment without the need for voice contact by as many telephone calls.

Each healthcare facility will have the ability to create a unique employee profile template. This template, once created by the healthcare facility, is designed to retain the personal information of each approved healthcare professional and creates a method to sort for a specific employee category within a general employee type. A separate employee profile template is created for each employee type, e.g., Doctors, Registered Nurses, Licensed Practical Nurses, etc. One example would be a healthcare facility looking for a Registered Nurse who is qualified to work in the operating room, among all their approved Registered Nurses. In this way, those professionals who have been approved by the facility can be directly offered temporary positions that fit unique customized criteria, which criteria were created and compiled by the specific healthcare facility.

Based on the requirements for the temporary position, a facility may offer the position to a single registered professional, to a limited number of registered professionals, or to all of the professionals approved by that facility who are registered in the database. Potentially hundreds of registered professionals can be offered the temporary position within a matter of minutes. As soon as one professional accepts the temporary staffing offer, the posting is removed, both parties receive a confirming e-mail message containing the details of the temporary position and the calendars of both the hiring facility and the registered professional are updated with the information pertinent to the temporary assignment.

Qualified healthcare professionals previously unable to meet availability requirements of temporary staffing agencies due to scheduling conflicts, family commitments, etc. will now be able select temporary employment suitable for their schedules. In the past, temporary personnel not readily available to take on part-time work, were overlooked by both in-house personnel departments and temporary agencies because handling these personnel was not cost effective when balanced against their limited schedules and the time necessary to contact and confirm the employment. Even full-time healthcare professionals can be encouraged to register to meet temporary staffing requirements and earn additional compensation. The ability of the present invention to coordinate between the hiring facility and the available healthcare professional having the right skills has the potential to make available a large number of potential temporary staff, adding these professionals to the pool of professionals currently being used, to alleviate an industry shortage of qualified personnel and to expedite the process of fulfilling temporary staffing requirements.

It is, therefore, an object of the present invention to provide an interactive web-based database that permits all potential employees, in a specific profession or industry, to have direct contact with all potential employers in that same industry, and vice versa, in order to coordinate temporary staffing opportunities and expedite the process for filling temporary positions.

It is also an object of the present invention to allow for the direct solicitation of temporary employment offers from employers to the corresponding industry employees without the need for an Intermediary.

It is also an object of the present invention to provide the capability to allow employers to build their own unique sorting criteria for each employee type in order to sort through their approved list of potential employees to identify those employees meeting the specific requirements of a particular job.

Another object of the present invention is to allow the temporary employee, of a specific profession or industry, to seek out temporary employment by registering on the interactive web-based database in order that one or more employers, in that same profession or industry, can learn of the availability of the professional based upon desired geographic area and availability for employment, and to subsequently review the professional's credentials and experience in order to solicit that professional for approval with that employer so as to receive future temporary position offers.

Other objects will appear hereinafter.

### SUMMARY OF THE INVENTION

The present invention is directed to an interactive web-based database for use by any of a plurality of professions and industries, e.g. healthcare facilities and healthcare professionals, to coordinate the availability of the professionals with the temporary staffing requirements of the hiring facilities. The database, and access thereto, is designed to permit hiring facilities to more easily schedule assignments for temporary professionals while giving those professionals greater freedom in selecting their assignments by allowing them to view and accept offers from a number of hiring facilities. Hiring facilities will be permitted to search the database for potential temporary staff, approve those professionals who meet their specific requirements, post available temporary positions to those professionals based on additional job specific criteria also created by that hiring facility, notify those professionals of temporary positions, offer the temporary position in waves determined by the hiring facility, maintain data files of qualified professionals, and communicate with large groups of industry-related professionals through broadcast e-mail messaging.

Industry specific professionals will be able to specify their employment type, e.g. for the Healthcare Industry—Physician, Registered Nurse, Pharmacist, etc., and the time(s) and locations in which they desire to work. Registered user professionals will be able to communicate with hiring facilities to solicit employment and, once approved by a hiring facility, be able to accept temporary employment offers. Each professional will have control over the types of information shared with the hiring facilities.

The present invention is designed such that hiring facilities will have a number of user levels so that user accounts, which limit or de-limit access to certain information and temporary employment postings, can be created. A hiring facility overall administrator, master user, or “Superuser” for each facility, will control the access of each additional user for that facility by assigning them to one of three categories, Superuser, Admin., or Scheduler, thus determining the amount and type of information accessible at assigned user levels.

The invention may be further summarized as a method for obtaining staffing for one or more temporary staffing opportunities for a hiring facility utilizing an interactive database accessed through an Internet telecommunications connection available to both the hiring facility and to temporary staffing personnel which comprises the steps of providing a computer for storing the interactive database containing information pertaining to registered users and temporary staffing opportunities posted by one or more hiring facilities, the registered users being one or more temporary staffers and one or more hiring facilities, providing access to the interactive database by one or more temporary staffers upon completing registration and assignment of a secure login username and password and providing access to the interactive database by said one or more hiring facilities upon completing registration and assignment of a secure login username and password. Creating and posting a temporary staffing offer on the interactive database by one of the one or more hiring facilities to a selected recipient group of the one or more temporary staffers by updating calendar information of each of the selected recipient group of the one of more staffers and the one of the one or more of hiring facilities to display a temporary staffing offer and the reviewing of the temporary staffing offer posted on the interactive database by the selected recipient group of the one or more temporary staffers by viewing their respective calendar information. This is followed by the receiving of an acceptance of the temporary staffing offer on the interactive database from one of the selected recipient group of the one or more temporary staffers by updating the calendar information of the one of the one or more hiring facilities and the one of the selected recipient group of the one or more temporary staffers to display an accepted temporary staffing offer, and by updating the calendar information of the remaining one or more temporary staffers of the selected recipient group by deleting the display of the temporary staffing offer. The sequence concludes with the automatic transmitting a confirming e-mail message to both the one of the one or more hiring facilities and the one of the selected recipient group of the one or more temporary staffers acknowledging the acceptance of the temporary staffing offer.

The method further comprises the step of creating the selected recipient group of one or more temporary staffers by matching a hiring facility created set of profession related questions, limited to an employee type within said profession with a set of hiring facility created temporary staffing requirements, the matching resulting in a listing of temporary staffers possessing the temporary staffing requirements. This is further refined by the step of ranking the selected recipient group according to a hiring facility set of parameters for arranging the selected recipient group listing in descending order for the highest ranked temporary staffer. This is still further refined by the step of deferring the transmission of the temporary staffing offer to a number less than all of the selected recipient group based upon the ranking the selected recipient group by a designated time period.

The method step of registration also includes the providing of information pertinent to the identifying of the one or more hiring facilities for storing in the interactive database for later retrieval and use in displaying information about the one or more hiring facilities and the providing of information pertinent to the identifying of the one or more temporary staffers for storing in the interactive database for later retrieval and use in displaying information about said one or more temporary staffers. The method step of creating and posting a temporary staffing offer also includes the providing of information pertinent to the temporary staffing position by the one of the one or more hiring facilities.

The calendar information of each of the one or more selected recipient group of the one of more staffers is displayable on the interactive database in monthly, weekly and daily formats, and includes an icon denoting each of a set of calendar entries, said entries including accepted offers, unaccepted offers and notes. Likewise, the calendar information of each of the one of the one or more of hiring facilities is displayable on the interactive database in monthly, weekly and daily formats, and includes an icon denoting each of a set of calendar entries, said entries including filled offers, unfilled offers and notes.

The method step of receiving an acceptance of a temporary staffing offer further includes the checking of the temporary staffer's calendar for other accepted temporary staffing offers from any of the one or more hiring facilities to determine an overlap between accepted offers and any working period for accepted offers exceeding a sixteen hour maximum work period within a twenty-four hour day making the temporary staffer unavailable for the conflicting temporary staffing offer and temporary staffing offers exceeding the sixteen hour work period. The method also includes the automatic notification of a temporary staffer of a license or certification expiration date by automatically generating an e-mail text message to the temporary staffer within a pre-defined time period, and providing a copy to any hiring facility having an accepted temporary staffing offer by the temporary staffer for work to be perform within the pre-defined period.

### BRIEF DESCRIPTION OF THE DRAWINGS

For the purposes of illustrating the invention, there is shown in the drawings, forms that are presently preferred; it being understood, however, that the invention is not limited to the precise arrangements and instrumentalities shown.

FIG. 1 is a block diagram of the web-based home page of the interactive database of the present invention.

FIG. 2 is a block diagram of the interactive database promotional tours for healthcare professionals and facilities managers and user registration.

FIG. 3 is a block diagram of the healthcare professional section of the interactive database of the present invention.

FIG. 4 is a block diagram of the healthcare facility section of the interactive database of the present invention.

### DETAILED DESCRIPTION OF THE PREFERRED EMBODIMENT

The following detailed description is of the best presently contemplated modes of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

The web-based interactive database can best be described in functional aspects as set out in the various Figures. It should be understood that the database is resident on a computer server that is accessible by connection with users over a secure (password protected) Internet link. The data collected and stored in the database in the various categories is protected from improper access by denying access to a non-user, or a prior registered user without the proper authorization. The full functionality of the database may be described as follows in terms of web pages resident on a website accessed through the Internet at a unique address. For ease of understanding, a single profession or industry, i.e. healthcare, is utilized so that references in the following description of the inter-related functionalities of the database will be to the healthcare industry. The employee types, or occupation identifiers, are selected and listed by the interactive database system administrator depending upon the profession or industry with which the database is to be utilized. It should be understood at the outset that the interactive database of the present invention may be similarly configured for use with any other profession or industry, e.g. teachers, secretarial and executive assistants, etc., other than the example of the healthcare industry used for ease of description of the inter-related functionalities of the database.

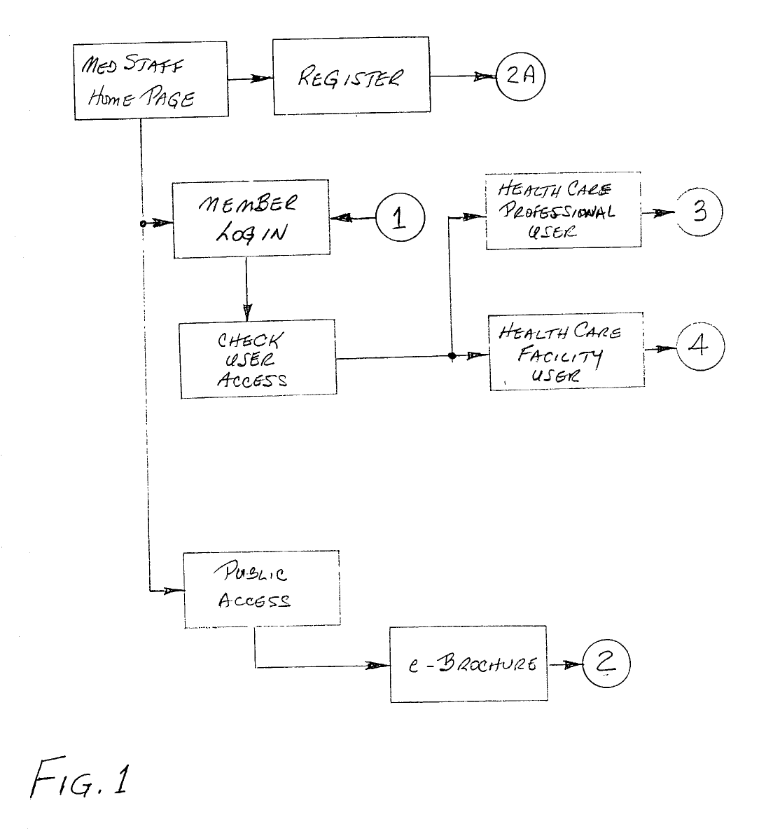

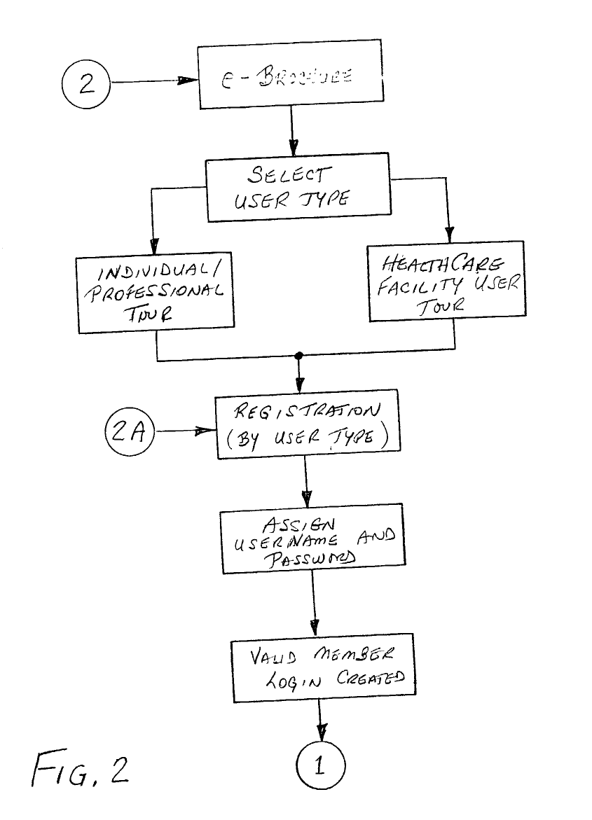

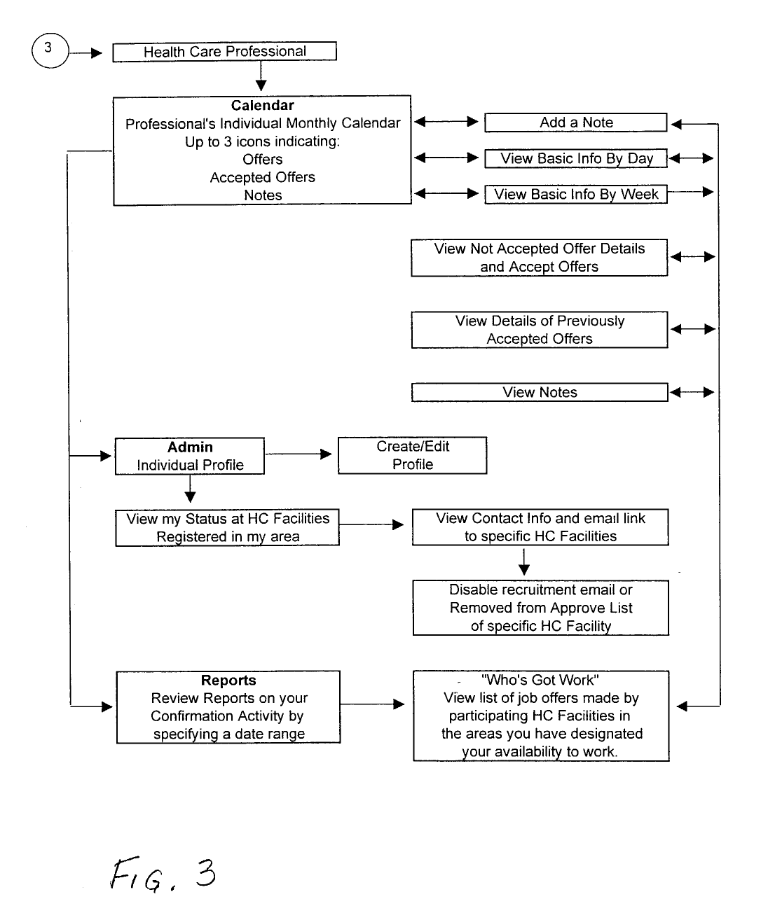

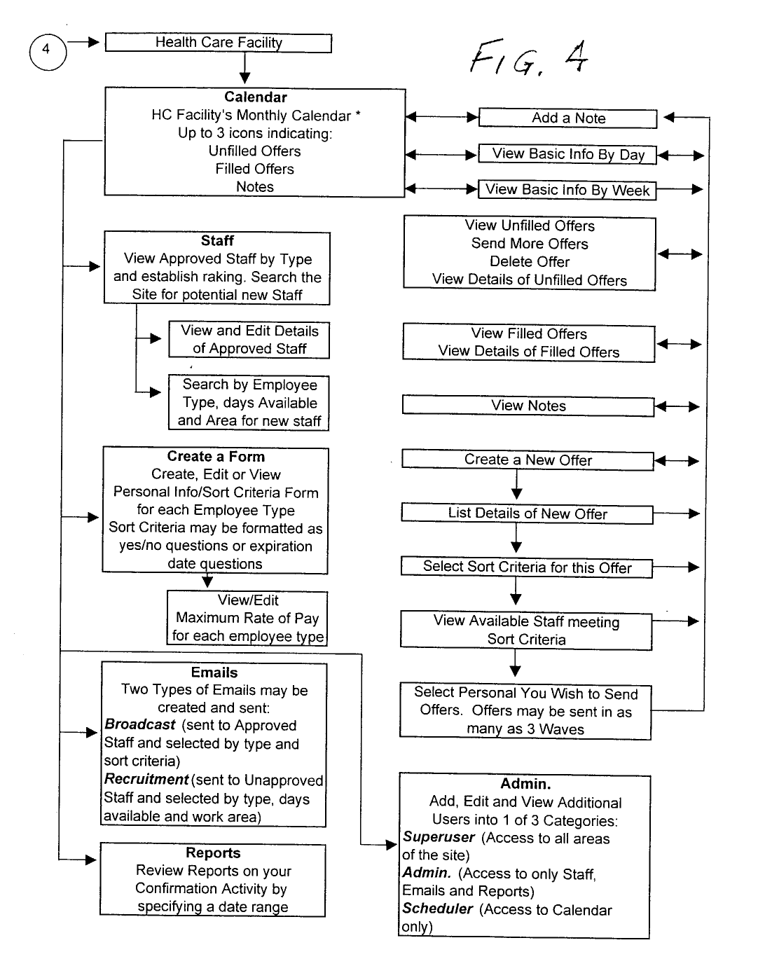

FIG. 1 represents the access functions required to gain admission to the web-based interactive database, denominated as MedStaff for use with the present example, by a new or registered user to the database. Public access to certain elements of the website are permitted. If a person who is not a registered user, but is interested in learning about the process of temporary staffing from either the professional or institutional viewpoint, such person may enter an area of the website called the e-Brochure section shown in FIG. 2. In the e-Brochure section, the prospective user may select either (or both) the Healthcare Professional Tour (for individuals) or the Healthcare Facility Tour (for institutional users) to view the various functionalities of the interactive database. Each of the Tours concludes with an offer to become a registered user of the website, with individual registration dependent upon the type of user, i.e. individual/professional or facility users which are later divisible into different levels of access. The prospective user, upon approval by the operators of the website and interactive database, will be issued a valid member login username and password. The member/user is now able to enter the website based interactive database through the user login shown in FIG. 1. Security for the website interactive database is maintained through the use of a valid login username and password. Based upon the prior election of user type, the registered user is automatically routed to the appropriate link or section of the database, e.g. the Healthcare Professional User, hereinafter referred to as professional or employee, web section shown in FIG. 3 or the Healthcare Facility User, hereinafter referred to as hiring facility or employer, web section shown in FIG. 4.

Referring now to FIG. 3, once login to the database is completed, the professional's homepage will be displayed with a number of “tab links” permitting the user to switch between informational pages displayed on the computer screen. The employee or professional user will have access to three professional user sections: CALENDAR, ADMIN AND REPORTS. The professional user homepage displayed upon proper login shows the Calendar page as the default display. The Calendar page displays a month view showing each day in a row set off in vertical weekly increments from Sunday through Saturday.

From the monthly Calendar view, the professional user is able to see up to 3 icons displayed in any of the “boxes” denoting a single day/date indicating “Offer Accepted”, “Offer Not Accepted”, and “Notes”. The “Offer Accepted” icon is displayed as a card overlaid by a checkmark indicating a temporary assignment as a specific hiring facility. The “Offer Not Accepted” icon is displayed as a card without the checkmark. Both of these icons serve as a link to the specific temporary assignment information whether or not employment was accepted. The “Notes” icon is displayed as a card overlaid by a grouping of figures which also acts as a link to the note information. Notes can be added to any day simply by clicking the “Add a Note to This Day” button and setting the date to the desired day for the Note within the designated box on the Notes page. When the Notes page is selected the default day/date is the active date. The date can be changed, by modifying the date field, and the note can be typed in the space provided as prompted.

The CALENDAR pages for each professional user will display his or her activity is and individual note information in the selected format, monthly, weekly or daily. The professional user may also select either a weekly or daily view of his or her individual staffing and note information for access to additional details of the information represented by the icons. In either the weekly or daily view of the Calendar pages, the display is segregated into sections listing the accepted and not accepted offers of temporary employment and the individual notes. In the weekly view, the calendar for that week may be repeatedly display in each of the segregated listings in a preferred horizontal stacked format such that each day is shown in each of the categories. This enables the professional user to click on any day/date and have the daily view displayed, while seeing exactly the assignments for the selected week.

The daily view also provides a segregated display of the assignment offer, whether or not accepted, and the individual notes in a stacked horizontal display. However, in the daily view additional information indicating the hiring facility, department, shift, and professional type for accepted and not yet accepted offers is displayed. Also, the note information is displayed for the selected day/date. Links are provided so that the professional user may display the previous or the next day from the displayed day/date.

From either the daily or weekly views the professional user may view the “Not Accepted” offers, the “Accepted” offers and “Notes” with the respective icons preceding the listing of assignments and notes. There is a link within each “Not Accepted” offer and each “Accepted” offer allowing the user to view the complete detail of that offer. The Offer Detail display includes the information set forth in Table 1

TABLE 1
TEMPORARY EMPLOYMENT INFORMATION

| | |
|---|---|
| Staffing Position | Professional Type and Shift |
| Reporting Location | Department |
| Date of Employment | Assignment Date |
| Pay Rate | $$/Hr. |
| Start Time | Hour |
| Completion Time | Hour |
| Staffing Ratio | Professional Types List |
| Contact Information | Person, Telephone, E-mail |
| Employee Type | License Type |
| Hiring Facility | Name |
| Reporting Address | Street Address |
| Travel Directions | |
| Special Instructions | |
| Accepted | Yes/No |
| Cancellation Terms | |

In this way a professional user may view and accept posted staffing offers for temporary employment from a variety of healthcare facilities, for which the user has been approved to receive offers. From the daily view page the professional user may also add individual notes by accessing the “Add a Note to This Day” link and the page for creating the Note will appear.

As a professional user reviews temporary or part-time employment offers from a hiring facility and finds an offer that is of interest to the professional, the user may simply click on the “Accept” button appearing on both the daily view page and the Offer Details page to accept the offer utilizing the database as the vehicle for transmitting such acceptance. The interactive database, upon entry of an indication accepting an offer of temporary employment by a professional user, will instantaneously confirm the acceptance of the offer by way of updates to both the healthcare professional and the healthcare facility respective calendars (indicating an “Accepted” offer to the professional and a “Filled Offer” to the facility) and by way of confirming e-mails containing the offer details to both parties. Upon acceptance of an offer of temporary employment by the professional user, any other conflicting outstanding offers to the healthcare professional will be dropped and the professional will be considered unavailable to any new conflicting offers. A conflicting offer is one that either overlaps the accepted offer (or offers) by day and time, or any offer that would permit the healthcare professional to accept more that 16 hours of work within any 24 hour period.

The ADMIN section, for the professional user, was designed to create, and later edit, his or her individual Profile containing detailed information pertaining to the individual healthcare professional such as name, address, employment type (e.g. Physician, Registered Nurse, Pharmacist, etc.), desired times for work, desired locations for work, etc. A professional will not be able to edit his or her employment type, i.e., occupation identifier, after initial registration is completed and approved. The “Profile” page is displayed when the Admin “tab” is selected. Information can be later added to the professional Profile, or deleted or changed as circumstances may require. From this section or page, a professional user may also view “Healthcare Facility Info” by clicking the link provided on the page which shows the user's “Approved” status (approved or not approved by the hiring facility) with each of the registered hiring facilities in the geographic areas of work selected by the professional and recruitment status for the professional. These indicia indicate whether or not a professional wishes to receive recruitment e-mail from registered hiring facilities. By clicking on the name of the facility the professional user may view the contact information for the selected hiring facility as set forth in Table 2 below.

TABLE 2
HIRING FACILITY INFORMATION

| | |
|---|---|
| Hiring Facility | Name |
| Street Address | |
| City, State, Postal Zipcode | |
| Contact Person | Name |
| Contact Information | Telephone, E-mail |

The professional user is able to toggle a status button that permits recruitment e-mails from each of the registered hiring facilities on the individual hiring facility profile page. The professional user is also able to toggle the status button for “Approved” status of one or more hiring facilities, once the professional has been approved for temporary employment in that facility, to disable further offers of employment from that facility. This is also accomplished from the individual hiring facility profile page. The same is true for the recruitment e-mails, once the professional user has disabled further e-mails, only the professional user can reset the toggle and again receive recruitment e-mails from the particular hiring facility.

The REPORTS tab, for the professional user, is designed to create a Confirmation Report based upon the date parameters set by the professional. Upon selecting the Reports tab the Confirmation Report page is displayed As the professional user completes the date parameters (beginning and end date) for the Report, the specific Confirmation Report for the designated date parameters provides the details of each accepted temporary assignment by displaying, for each assignment, the date, start time, hiring facility, reporting location, position required, pay rate, and whether the assignment was canceled prior to the assignment start time. This Report can be printed out at the professional user's local computer/printer and retained for portable schedule confirmation.

The professional user may also view an abridged description of offers by participating healthcare facilities by his or her employment type, i.e. Registered Nurse, etc., that are currently available in the areas in which they have indicated a willingness to work by accessing the link ‘Who's Got Work” on the Reports pages. “Who's Got Work” lists the facility, employee type and pay rate for the temporary assignment. One purpose for viewing posted offers for specific employment types is for a user to see what kinds of temporary assignments are “out there” in the selected geographic area using the interactive database that have not been offered to the professional. This is so a user may contact that hiring facility in order to be considered as an approved employee and receive future solicitations for temporary or part-time employment. A direct link to “Who's Got Work” is also available on the Calendar pages.

Referring now to FIG. 4, the initial registration for the hiring facility user follows the same steps as described above in connection with the individual/professional user with the user type now indicated as being a facility for providing some form of healthcare. This hiring facility may be a hospital, nursing home, assisted living residence, hospice, etc. Once registration of the hiring facility has been approved by the database website operator, the system issues a username and password to the designated overall administrator, master user, or Superuser for the Facility. The Superuser has complete access to the hiring facility's pages and information within the database. FIG. 4 shows all sections of the database available to the hiring facility, although some sections may not be available to lower tiered users later added by the master user or Superuser.

The hiring facility's site is divided into five sections: Calendar, Staff, Create Form, E-mails, Reports and Admin. From the Calendar section (a monthly view), the hiring facility user will see the same 3 icons described above in connection with the professional user's calendar but, in this case, the displayed icons indicate “Unfilled Offers”, “Filled Offers” and “Notes”. The facility user may also select a weekly or daily view for the additional informational details represented by the icons. From the daily view the facility user may view “Unfilled Offers”, “Filled Offers” and “Notes”. There is a link within each “Unfilled Offer” and “Filled Offer” allowing the viewer to see the complete detail of that offer for the selected day/date. In the weekly calendar view the temporary assignments are listed by department or location within the facility and segregated in the same manner by filled or unfilled offers and notes in a stacked horizontal display. If the facility user wishes to review a listing in more detail the link is selected and the “Position Offer Details” are displayed. The information provided to the facility user is set forth in Table 3 below.

TABLE 3
TEMPORARY EMPLOYMENT OFFER INFORMATION

| | |
|---|---|
| Staffing Position | Professional Type and Shift |
| Reporting Location | Department |
| Date of Employment | Assignment Date |
| Pay Rate | $$/Hr. |
| Start Time | Hour |
| Completion Time | Hour |
| Coverage Area | [Nursing—No. of Patients] |
| Staffing Ratio | Professional Types List |
| Employee Replaced | Name |
| Contact Information | Person, Telephone, E-mail |
| Employee Type | License Type |
| No. of Temp. Employees | |
| Reporting Address | Street Address |
| Travel Directions | |
| Special Instructions | |
| Cancellation Terms | |
| Special Requirements | |

Although the listing of detailed information in Table 3 is similar to that of Table 1, the information is different as there are certain additional types of information provided for the employing or hiring facility. In the case of an “Unfilled Offer”, the detailed information also includes a listing of the names of those professionals receiving the offer of the temporary assignment and, if the offer was sent in waves, the times those offers were, or will be sent. The hiring facility user has the option of sending an offer for temporary employment in “waves” such that a restricted list of professionals will receive the offer immediately, these likely being the approved professionals who have already been employed on a temporary or part-time basis with the facility previously, other approved professionals will received the offer after a delay time following the first listing set by the facility user, and if the offer remains unfilled subsequent to a second delay time period all remaining selected professionals will receive the offer via updates to their respective Calendars accompanied by a basic text e-mail providing notice to the professional that a temporary employment offer has been made by a hiring facility. The listing of professionals for potentially receiving the offer is displayed in a predetermined ranking of approved professionals which sequenced listing is available to the facility user(s) when creating an offer of temporary employment to be discussed further below.

The listing of which registered professionals received the offer of temporary employment, in the segregated wave format, also shows the offer(s) were sent, and if not already sent, when the offer(s) will be sent. As the offers are made, the Calendars of the recipient professionals and the hiring facility are updated to contain the offer information. As explained previously, an accompanying e-mail is sent to the recipient professionals providing notice that a new offer has been made by the particular hiring facility. The listing also provides indicia of which professional accepted the offer and also provides appropriate “buttons” (links) to delete an offer which has yet to be accepted and to cancel or rescind an offer that has already been accepted. In the case of a cancelled or rescinded offer, the database generates an automatic e-mail to both parties acknowledging the action taken by the hiring facility.

From the daily view page the facility user may create a new offer of temporary employment by “clicking” the “Create a new offer on this day” button or add a note by clicking the “Add a Note to this day” button. The adding of a note is the same as for the professional user, the Notes page appears with areas for information to be filled in by the facility user. For the facility, the note may be written for a particular department (if created by a Superuser of a facility), in addition to being associated with a particular day. When the note is completed, the “Add” button is clicked which adds the note to the database and the note icon to the facility calendar on the selected day/date. It is important to understand that the facility may have a number of users of the interactive database, each possessing a different level of access, such that there will exist a combined facility Calendar accessible by one or more Superusers at the facility, as well as Calendars containing more limited information, for example a Calendar for use by a single facility department will display only the offers and notes for that department.

For the facility user authorized to create an offer, i.e., a Scheduler, there are three steps for creating an offer of temporary employment. The first step requires selection of the day/date on the Facility Calendar and clicking the create a new offer button. The Scheduler user is presented with a screen display which requires the filling in of detailed information about the temporary assignment including the information listed in Table 4 below.

TABLE 4
TEMPORARY EMPLOYMENT REQUEST INFORMATION

| | |
|---|---|
| Requesting Department | Department Identifier |
| Staff Position Required | Staffing Identifier |
| Employee Type | [RN, etc.] |
| Pay Rate | $$/Hr. |
| No. of Staff Required | |
| Replacing | Employee Name |
| Location/Coverage | Dept. Name/No. of Patients |
| Staff Ratio | |
| Travel Directions | |
| Special Instructions | |
| Start/End Times | Hrs. |
| Cancellation Terms | |
| Contact Information | Name, Telephone, E-mail |

When complete, the Scheduler user clicks the Proceed button following the fill-in form and the second page of the Create an Offer is displayed. This page lists a number of criteria necessary for the temporary position, which criteria provides a sorting basis to limit the offer to only those professionals possessing the required experience and/or credentials. This step sets the sort criteria for the employee type chosen on the preceding page. e.g., Registered Nurse for Critical Care Department, with a list of licensure, credential and specialized work experience criteria as set forth in Table 5 below.

TABLE 5
TEMPORARY EMPLOYMENT REQUIREMENTS

| | |
|---|---|
| State Practice License | Expiration Date |
| Additional Certification(s) | Expiration Date(s) |
| Specialized Work Experience | Yes/No |

This sorting criteria is created by each hiring facility to manage its own work force and may be the same, or different from other facilities. The criteria is generally structured for Yes/No type questions, with some responses providing dates of expiration for licensure or certifications. This sorting criteria, unique to each hiring facility, is the basis for determining which of the registered and approved professionals meet the requirements for the temporary employment offer. For example, when searching for a registered nurse with experience in an emergency department setting, the facility user would be requiring a Yes response to all questions relating to the specific temporary position. When completely filled in by selecting one or more specialized working experiences, certifications and licensing criteria which establishes the sort criteria for finding the registered professionals who have the capabilities for fulfilling the duties of the temporary assignment, the Scheduler clicks the Proceed button on the page and the Create an Offer displays a third page in the series which permits the Scheduler user to delineate the timings of delivering the offer of temporary employment to one or more professionals meeting the criteria who are registered in the database.

The last page of the Create an Offer provides a segregated listing of names of professionals who have met the criteria for the assignment requirements. A Contacts Listing appears with a list of the names of the professionals from the facility's list of approved professionals previously entered into the database, who meet the assignment requirements criteria. From this listing the Scheduler can select one or more professionals to be contacted with the offer of temporary employment. When selected, a professional's name will be placed in the Recipient List for receiving the offer of work.

When the Recipient Listing is completed for either a single, or multiple wave offer, the Scheduler again clicks the Proceed button and the calendars of the hiring facility and the professionals on the Recipient Listing will be updated with the offer. In addition, e-mails containing the offer information will be sent to the professionals listed in the Recipient List in either a single transmission, or in waves delayed by selected times.

The Scheduler already selected from the Contact List those professionals who will be sent the offer of temporary employment and transferred those names to the Recipient List. As the offer may be sent in one to three waves, with time intervals determined by the sender, i.e. the Scheduler, there will be up to three Recipient Lists containing the names of those professionals who will be contacted at timings determined by the Scheduler. The delay between the first and second waves may be set by the Scheduler manually on the third page of the Create an Offer section of the database by entering the number of hours, or tenths of hours, between transmissions. The Scheduler can also set another delay for the time between the first wave and the third wave of transmissions. The purpose for providing the time delay in making the offer is to allow the Scheduler to give higher-ranked approved professionals an advantage in receiving the offer of the temporary assignment sooner then other professionals who will be contacted at a later time.

In this manner the offering of temporary or part-time employment is accomplished without the need for numerous telephone calls to ascertain staffing requirements, temporary staff availability, and coordination of personnel to fill the one or more temporary assignments on a daily basis. All of the interpersonal exchanges are reduced to electronic communications generated by use of the interactive database which retains the information pertinent to registered users and job assignments and presents the information in an easy to use calendar scheme.

The STAFF tab of the facility user's page allows access to the facility's list of approved professionals by employee type as well as the capability to search the database for new professionals who have become registered users. A listing of employee types, for example in regard to the healthcare example being used in this description; Registered Nurse, Nurse Practitioner, Doctor, Pharmacist, etc., of those professionals who have been previously approved for temporary employment by the facility can be viewed by a facility user. By selecting an employee type from the “Approved” list on the Staff page, a listing of those Approved Employees will appear in the order in which they have been ranked. The listing also provides indicia of the number of confirmed temporary assignments the professional has achieved using this interactive database. Ranking of the professional within an employee type grouping provides the facility user with a method for seeking the temporary employee who may be most familiar with the facility's requirements and needs, as well as the temporary employee who has worked the most for that facility. Those employees who have been ranked highest will appear at the beginning of the listing. Changing the ranking may be done by modifying the ranking number for one or more professionals and updating the database when completed. This resets the ranking order for this employee type grouping of approved employees.

By clicking on the name of one of the professionals in the list the facility user will be able to view and edit that professional's personnel information maintained by the facility as an Employee Profile. The personnel information for the temporary employment of a professional may include information such as listed in Table 6 below.

TABLE 6
EMPLOYEE PROFILE OF HIRING FACILITY

| | |
|---|---|
| Employee Name | |
| Employee Contact Information | |
| Employee Personal Information | |
| Employee Pay Information | |
| Available for Work | Days/Times |
| Geographic Limits | City/County/State |
| Employee Type | [Doctor, Nurse, Tech.] |
| Licensure/Certification | Expiration Date(s) |
| Special Work Experience | |
| Work Experience w/Facility | |

Information in the personnel, or profile section of a facility temporary employee can be modified by the facility user, as may be necessary. The information contained in the Employee Profile that forms the basis for the searching or sorting criteria are the Yes/No, expiration and text type questions contained in the last three categories of Table 6, the Employee Profile Template. It is this information that is matched against the requirements for employment established by the hiring facility that will produce a list of possible professionals able to fulfill the temporary assignment. The list of questions is created by each hiring facility and will be discussed in greater detail below in connection with the creation of forms for use on the database. In addition, a previously approved temporary employee may be removed from the approved listing by a hiring facility user simply by clicking the “Remove from Approved List” button. An e-mail link is also provided for quick access to that employee.

Going back to the Staff page listings of Approved and Unapproved temporary employees, a Scheduler will be able to search the database for all registered professionals based on the area where the professional desires to work, the days of the week the professional is available, and the type of employee by clicking on the “Unapproved” link. This action displays a search page that lets the facility user look for temporary employees by type, geographic area, and availability to work by day and time. The result of the search will produce a listing of all professionals that meet the search criteria so that solicitations for temporary employment may be made to persons on the search results listing. When the list of potential professionals for approval is displayed, the facility user may click on the name, which results in the display of the basic information for the professional. Clicking the “Approval” button adds that professional to the facility's approved list of employees and displays, below the basic employee information, the Employee Profile information from the template for the employee type for the now approved professional to be completed by the facility user.

The CREATE FORM tab of a registered facility's page is designed to allow each facility to create a unique Employee Profile Template for each employee type. By selecting an employee type from a preset listing of employee types for the profession or industry, a template may be created or edited. The template is designed to allow the facility to create and sequence any number of questions or text information. The questions may be in the form of a Yes/No, Expiration Date or Text question that will become the criteria by which future offers for this employee type will be searched and sorted. Hence, for each employee type, a hiring facility may create a set of criteria that is relevant to how it wishes to organize and manage its temporary staffing, enabling the hiring facility to locate and offer temporary employment to a plurality of approved professionals without the need to sort through paper files listing each potential employee's skills and credentials. The Employee Profile Template, as created or edited for each employee type, is utilized as the basis for completing the Employee Profile so that matching of potential temporary employees (professionals) to new temporary employment offers can be automatically accomplished through use of the interactive database of the present invention. While creating the template for a particular employee type, it is also possible to establish or edit the maximum pay rate that may be offered for this position by clicking an “Additional Information” button. The maximum rate of pay may be entered and the database updated with the form, as created and/or modified, so as to be available for use in the Staff section.

Based upon any data furnished by the staffing professional in response to a question seeking expiration dates for licensing or certification requirements, the interactive database will automatically create and transmit a notice of impending lapse or expiration of a license or certificate to the professional. The notice will be transmitted within a preset time period, for example thirty (30) days, prior to the expiration date to the professional, with a copy to any facility in which the professional will be employed within the period. The notice is designed to serve as a reminder of the expiration so that updated information can be obtained of license renewals or re-certification by the professional.

The E-MAIL tab of a registered facility's page is designed to allow a facility user to send Broadcast e-mails and Recruitment e-mails to registered individual/professional users. In either case a selection can be made to use existing e-mail text (created earlier by the facility user) or to create new e-mail text. Broadcast e-mails are intended to be sent to those professionals who are approved by the facility. In creating the e-mail transmission request, the sender's name, subject, and transmission date are entered, and the e-mail text recalled or new text message written. Once the e-mail is created and ready to be sent, the sender (facility user) will be able to select the employee type that will receive the e-mail. After the employee type has been selected, additional sorting criteria, i.e. the employee profile template for the selected employee type, will be displayed allowing the facility user to be more specific when directing text information and newsletters to its temporary employees. When the broadcast e-mail message is complete, the e-mail is automatically transmitted by the database in accordance with the date specified for transmission.

Recruitment e-mails are intended to be directed to those registered professionals who have yet to be approved by the facility. Recruitment e-mails work much the same as Broadcast e-mails except the sort criteria for sending these e-mails is based on the employee type, work area a professional selected, and days available. A search for potential recipients of the recruitment e-mails is accomplished in the same manner as a search for new temporary employees. The database will be accessed for a listing of all registered professionals who meet the criteria selected: employee type, geographic locale for working, and availability of the professional. These e-mail messages are sent at the times previously selected and automatically transmitted by the database to the list of recipients.

The REPORTS tab of a registered facility's page is designed to allow that facility to create a series of reports, i.e. a Confirmation Report (of temporary employee accepted assignments) based on the date parameters set by the facility user. The Confirmation Report provides specific details relevant to the parameters of the inquiry to the database. This report includes information as set out in Table 7 below.

TABLE 7
CONFIRMATION REPORT

| | |
|---|---|
| Date of Assignment | mm/dd/yyyy |
| Reporting Time | AM/PM |
| Department | |
| Position Type/Shift | |
| Accepting Professional | Name |
| Assignment Status | Cancelled? |

The assignment status shows the facility user whether the temporary employment was completed or cancelled and that the professional may be due some limited payment with regard to the cancellation terms expressed in the original accepted offer. The Confirmation Report also allows the facility user to monitor the rate of pay for different professionals based upon experience, number of temporary assignments for the facility, and similar criteria. Although, in some instances, the pay rates may be restricted to certain facility users and not others as discussed more fully below.

The ADMIN tab of a registered facility's page is designed to allow the master facility user to create additional facility users access to the facility's database information. The master facility user, predetermined to be a Superuser as described below, may add other facility users to any of three categories: Schedulers, Administrators or Superusers, each category being preset with either limited or unlimited access to the database. Superusers are permitted unlimited access to all tabs, or sections of the facility page and database including Calendar, Staff, Create Form, E-mails, Reports and Admin. Administrators are more limited by being permitted access to: Staff, E-mails and Reports. A Scheduler is significantly limited by permitting access only to the Calendar section of the database. Depending upon the user type, access to different tabs (or sections) of the database may be shown by grayed out or omitted links for tabs where access is not permitted.

As new Schedulers, Administrators, and Superusers are added by the master facility user, as he or she modifies the existing hiring facility account with the database, a new login name and password will be created by the database for each new designated user. As a requirement for a new user, that user's name and contact information is furnished to the database. The new user information, including database generated username and password, can be viewed by the master facility user. For each category of user, the master facility user can add or delete any other user for each category allowed. In the event that a particular user is no longer employed by the hiring facility in that position, the master facility user can deactivate that user.

The Superuser, as the overall administrator for the facility, oversees all operations and users of the registered facility's page in the database. The calendar viewable by a Superuser is a composite of all other calendars of the hiring facility, and therefore, Superusers will be able to view and edit all Unfilled Offers, Filled Offers and Notes. The master facility user may authorize any Superuser to add or delete user types and modify user type authority and access through the hiring facility Admin area of the database. Only a Superuser has access to the Create Forms and Admin tabs and pages, thus preventing other members of the hiring facility access to these sensitive areas.

Administrators may be viewed as the Human Recourses personnel of the hiring facility. They have access to the Staff, E-mails and Reports tabs and pages of the database. The Administrators will be doing the recruiting for the hiring facility, as well as managing and approving the professionals for the facility. Managing may include ranking the professionals, reviewing their qualifications, and editing the employee profile template created by the Superuser.

Schedulers are only permitted access to the Calendar tab and pages of the database, and further, access would usually be restricted to the calendar for a specific department. Therefore, besides creating offers of temporary employment for that department, Schedulers may only view and edit “Unfilled Offers”, “Filled Offers” and “Notes” created within that department. Schedulers assigned to specific departments will only have access to the Calendar for that department and will not have access to the personnel records of the professionals as entered in the database. Also, Schedulers will not have the capability to approve a professional as a desired temporary employee, or to edit an employee profile template.

By selecting a one of the three categories of users, the Superuser controls the access to the various sections of the database for the hiring facility. Small healthcare facilities may perform all functions with one or two Superusers, while larger facilities may assign some of the functions to various departments within the facility, or have an Intermediary perform some of the functions.

As stated above, the present invention of the interactive web-based database was described in connection with a single example set, i.e., healthcare professionals and facilities. The invention can be utilized with other professions or industries such as in educational staffing for public, private or parochial schools, colleges and universities, etc. In each instance of use of the interactive database, the various criteria for setting the employee types would be adapted to the particular profession or industry in which temporary staffing is required.

The specific advantages achieved by utilization of the interactive database of the present invention are that the staffing professionals and the hiring facilities are able to contact each other directly, without the need for an Intermediary, on a peer-to-peer basis. Thus, each staffing professional has access to a plurality of registered hiring facilities simultaneously, as well as each hiring facility having access to all of the registered staffing professionals when making an offer of temporary employment. This provides the staffing professional with a greater flexibility in employment opportunities as he or she can be listed on the “approve” list of temporary employees at more than one hiring facility at the same time and receive offer of temporary staffing opportunities from each of the hiring facilities simultaneously.

Further, each hiring facility has the capability to build a private sort criteria for each employee type, unique to itself, by which it can sort from its approved list of staffing professionals those professionals who meet the particular staffing requirements for a temporary staffing opportunity. From the sorted list of approved staffing professionals, the hiring facility may then decide to which of the staffing professionals the temporary staffing offer will be sent, with the further option of permitting some of the staffing professionals to receive the offer earlier than others. It is important to understand that some of the information on the interactive database is shared between and among the hiring facility and the staffing professional, and vice versa, such as the temporary employment information, while other information remains private to the professional and to the facility.

The present invention may be embodied in other specific terms without departing from the spirit of essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A method for obtaining staffing for one or more temporary staffing opportunities for a hiring facility utilizing an interactive database accessed through an Internet telecommunications connection available to both the hiring facility and to temporary staffing personnel comprising the steps of:
a. providing a computer for storing the interactive database containing information pertaining to registered users and temporary staffing opportunities posted by one or more hiring facilities, said registered users being one or more temporary staffers and one or more hiring facilities;
b. providing access to the interactive database by said one or more temporary staffers upon completing registration and assignment of a secure login username and password;
c. providing access to the interactive database by said one or more hiring facilities upon completing registration and assignment of a secure login username and password;
d. creating and posting a temporary staffing offer on the interactive database by one of said one or more hiring facilities to a selected recipient group of said one or more temporary staffers by updating calendar information of each of the selected recipient group of said one of more staffers and said one of said one or more of hiring facilities to display a temporary staffing offer;
e. reviewing said temporary staffing offer posted on the interactive database by said selected recipient group of said one or more temporary staffers viewing their respective calendar information;
f. receiving an acceptance of said temporary staffing offer on the interactive database from one of the selected recipient group of said one or more temporary staffers by updating the calendar information of said one of said one or more hiring facilities and said one of the selected recipient group of said one or more temporary staffers to display an accepted temporary staffing offer and by updating the calendar information of the remaining one or more temporary staffers of the selected recipient group by deleting the display of the temporary staffing offer; and,
g. automatically transmitting a confirming e-mail message to both said one of said one or more hiring facilities and said one of the selected recipient group of said one or more temporary staffers acknowledging the acceptance of the temporary staffing offer.

2. The method of claim 1 further comprising the step of creating the selected recipient group of one or more temporary staffers by matching a hiring facility created set of profession related questions, limited to an employee type within said profession with a set of hiring facility created temporary staffing requirements, said matching resulting in a listing of temporary staffers possessing the temporary staffing requirements.

3. The method of claim 2 further comprising the step of ranking the selected recipient group according to a hiring facility set of parameters for arranging the selected recipient group listing in descending order for the highest ranked temporary staffer.

4. The method of claim 3 further comprising the step of deferring the transmission of the temporary staffing offer to a number less than all of the selected recipient group based upon the ranking the selected recipient group by a designated time period.

5. The method of claim 1 wherein the step of registration includes the providing of information pertinent to the identifying of the one or more hiring facilities for storing in the interactive database for later retrieval and use in displaying information about said one or more hiring facilities.

6. The method of claim 1 wherein the step of registration includes the providing of information pertinent to the identifying of the one or more temporary staffers for storing in the interactive database for later retrieval and use in displaying information about said one or more temporary staffers.

7. The method of claim 1 wherein the step of creating and posting a temporary staffing offer includes the providing of information pertinent to the temporary staffing position by the one of said one or more hiring facilities.

8. The method of claim 1 wherein the calendar information of each of said one or more selected recipient group of said one of more staffers being displayable in monthly, weekly and daily formats.

9. The method of claim 8 wherein each calendar information display includes an icon denoting each of a set of calendar entries, said entries including accepted offers, unaccepted offers and notes.

10. The method of claim 1 wherein the calendar information of each of said one of said one or more of hiring facilities being displayable in monthly, weekly and daily formats.

11. The method of claim 10 wherein each calendar information display includes an icon denoting each of a set of calendar entries, said entries including filled offers, unfilled offers and notes.

12. The method of claim 1 wherein the step of receiving an acceptance of a temporary staffing offer further comprises the checking of the temporary staffer's calendar for other accepted temporary staffing offers from any of said one or more hiring facilities to determine an overlap between accepted offers and any working period for accepted offers exceeding a sixteen hour maximum work period within a twenty-four hour day making the temporary staffer unavailable for the conflicting temporary staffing offer and temporary staffing offers exceeding the sixteen hour work period.

13. The method of claim 1 further comprising the step of notifying a temporary staffer of a license or certification expiration date by automatically generating an e-mail text message to the temporary staffer within a pre-defined time period, and providing a copy to any hiring facility having an accepted temporary staffing offer by the temporary staffer for work to be perform within the pre-defined period.
